(19) United States
(12) Patent Application Publication
(10) Pub. No.: US 2026/0067018 A1
(43) Pub. Date: Mar. 5, 2026

(54) Successive Interference Cancellation for Forward Phase Sensor using DAS

(71) Applicant: NEC Laboratories America, Inc., Princeton, NJ (US)

(72) Inventors: Yue-Kai Huang, Princeton, NJ (US); Ezra Ip, West Windsor, NJ (US)

(73) Assignee: NEC Laboratories America, Inc., Princeton, NJ (US)

(21) Appl. No.: 19/321,149

(22) Filed: Sep. 5, 2025

Related U.S. Application Data
(60) Provisional application No. 63/690,825, filed on Sep. 5, 2024.
(60) Provisional application No. 63/708,431, filed on Oct. 17, 2024.

(51) Int. Cl. H04J 14/02; G01D 5/353; H04B 10/073; H04B 10/25

(52) U.S. Cl. CPC H04J 14/0201; G01D 5/353; H04B 10/073; H04B 10/2589

(57) ABSTRACT

Disclosed is a WDM network in which both DAS and forward phase sensing systems are deployed at add/drop nodes of fiber links. Whereas DAS systems can monitor immediate fiber spans connected to the add-drop nodes, forward phase sensors will monitor an entire link between the nodes. With DAS providing precise locations of vibration sources at the immediate fiber spans, we utilize that information and successively subtract these vibration signals (by applying proper time delay according to their location) from the forward phase signal monitoring of the entire link. The resulting signal after successive interference cancellation (SIC) only contains phase information at intermediate fiber spans, effectively isolating those signal sources from the those retrieved by DAS.

### CROSS REFERENCE TO RELATED APPLICATIONS

This application claims the benefit of U.S. Provisional Patent Application Ser. No. 63/690,825 filed Sep. 5, 2024, and U.S. Provisional Patent Application Ser. No. 63/708,431 filed Oct. 17, 2024, the entire contents of which is incorporated by reference as if set forth at length herein.

### FIELD OF THE INVENTION

This application relates generally to environmental monitoring and sensing using distributed fiber optic sensing (DFOS) technologies. More particularly, it pertains the to the combined application of distributed acoustic sensing (DAS) and forward-based sensing to more precisely and accurately monitor and sense wavelength division multiplexed (WDM) optical networks.

### BACKGROUND OF THE INVENTION

Distributed Acoustic Sensing (DAS) is a DFOS technology that uses fiber optic cables to detect acoustic vibrations. It has a wide range of applications due to its unique capabilities. Its ability to detect small vibrations over long distances in real-time makes it a valuable tool for monitoring and protecting the environment. However, due to the reliance of DAS on Rayleigh back-scattering mechanisms, it is difficult for a single DAS system to monitor multiple spans of fiber in contemporary telecommunications networks due to the presence of isolators located at an output of inline amplifiers, as well as a low signal-to-noise ratio (SNR) of received backscatter signals traversing multiple amplifiers.

Forward-transmission-based sensing schemes have been shown to overcome these issues and can be applied to multi-span fiber networks. Forward optical-phase-based sensing—in particular—has shown promising results as its sensitivity can be 1-2 orders of magnitude more sensitive than state-of-polarization (SOP) monitoring. Forward phase sensing can be implemented using bidirectional laser interferometry, loop-back laser interferometry with additional RF carrier paths at a far-end, or directly recovery of optical phase from DSP of coherent optical transponders for WDM communication.

Unlike DAS, forward based sensing schemes do not inherently provide location information for the vibration signals. All phase changes incurred by the vibrations along a fiber route are accumulated into one signal stream. Determining a location along the length of the fiber route of the vibration relies on correlation of the received signals to identify correlation peaks. It is extremely challenging to isolate/separate different vibration signals from different locations, say, from different fiber spans, when there are multiple vibration sources along the length of the fiber. There are also background environmental noises depending on the fiber installation (aerial cable, road traffic, etc), making it more difficult to identify signal of interest.

### SUMMARY OF THE INVENTION

An advance in the art is made according to aspects of the present disclosure directed to a WDM network in which both DAS and forward phase sensing systems are deployed at add/drop nodes of fiber links. Whereas DAS systems can monitor immediate fiber spans connected to the add-drop nodes, forward phase sensors will monitor an entire link between the nodes. With DAS providing precise locations of vibration sources at the immediate fiber spans, we utilize that information and successively subtract these vibration signals (by applying proper time delay according to their location) from the forward phase signal monitoring of the entire link. The resulting signal after successive interference cancellation (SIC) only contains phase information at intermediate fiber spans, effectively isolating those signal sources from the those retrieved by DAS.

First, we combine the uniqueness of two sensing scheme to provide surprising, overall system performance improvements. Using DAS, we exhibit excellent localization characteristics, but its monitoring range cannot extend beyond the 1^{st} span in conventional WDM networks. Using forward phase sensing, we can monitor a whole link from node to node, but cannot separate the sources of the vibrations/acoustics and localization performance via correlation is poor. When combining both approaches, we remove the effect of signals monitored by DAS from the phase signal whole link, advantageously isolating signal sources in the intermediate links with higher fidelity.

A phase signal strength and location information retrieved by DAS are critical to ensure that the SIC algorithm works properly. As a forward phase sensing signal traverses through a link, the phase amplitude of each vibration source are accumulated according to a time when the optical signal passes through a corresponding segment. As such, it is necessary to apply, and our inventive technique does apply, proper time delays to the DAS phases during the SIC process. Advantageously, an artificial vibration/acoustic source can be placed at intermediate spans with known signal profiles to calibrate the SIC process.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative implementation of forward phase sensor and DAS for SIC in bidirectional WDM optical fiber links between two add-drop nodes. Two forward phase sensors are deployed for phase monitoring of each direction. Two DAS are used to monitor fiber spans immediately adjacent to add-drop nodes according to aspects of the present disclosure.

FIG. 3 is a schematic diagram showing illustrative implementation of forward phase sensor and DAS for SIC in bidirectional WDM links between two add-drop nodes. In this case, only one forward phase sensor is used for loop-back operation, and the number of DAS is two, according to aspects of the present disclosure.

FIG. 4 is a schematic diagram of an illustrative simulation of a two-span link with loop-back forward phase sensing and DAS according to aspects of the present disclosure.

FIG. 5(A) and FIG. 5(B) are plots showing simulated vibration signal waveforms in which: FIG. 5(A) shows Ø₁ (t) placed at 10-km, and FIG. 5(B) shows Ø₂ (t) placed at 30-km.

FIG. 6(A) and FIG. 6(B) are plots showing: FIG. 6(A) received forward phase signals for an entire link using a loop-back simulated vibration signal waveforms, and FIG. 6(B) shows a phase waterfall plot retrieved by the DAS for span 1 with 1-km spatial resolution.

FIG. 7(A) and FIG. 7(B) are plots showing: FIG. 7(A) received Retrieved loop-back phase signal for span 2 after SIC, and FIG. 7(B) shows autocorrelation results of the loop-back phase signal before (blue) and after (red) SIC process a phase waterfall plot retrieved by the DAS for span 1 with 1-km spatial resolution.

FIG. 8 is a plot showing autocorrelation traces of SIC processed phase signals with different time-shift errors according to aspects of the present invention.

FIG. 9 shows a feature diagram in a hierarchical format according to aspects of the present disclosure.

FIG. 10(A) and FIG. 10(B) show: FIG. 10(A) experimental setup using loop-back real-time phase and SOP sensing system and received, and FIG. 10(B) a plot of PSD laser phase noise showing Amplitude vs. Frequency according to aspects of the present disclosure.

FIG. 11 is a schematic block diagram of an illustrative computer system on which methods according to the present disclosure may operate.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

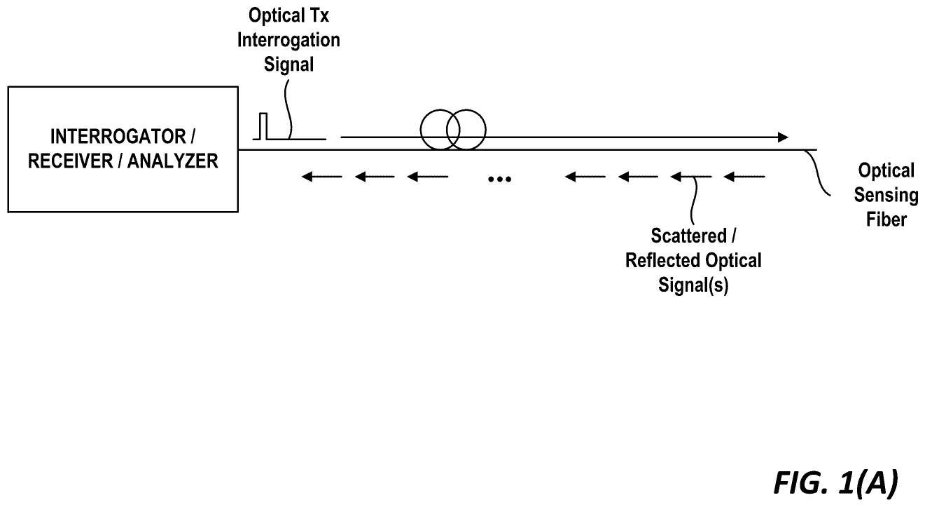

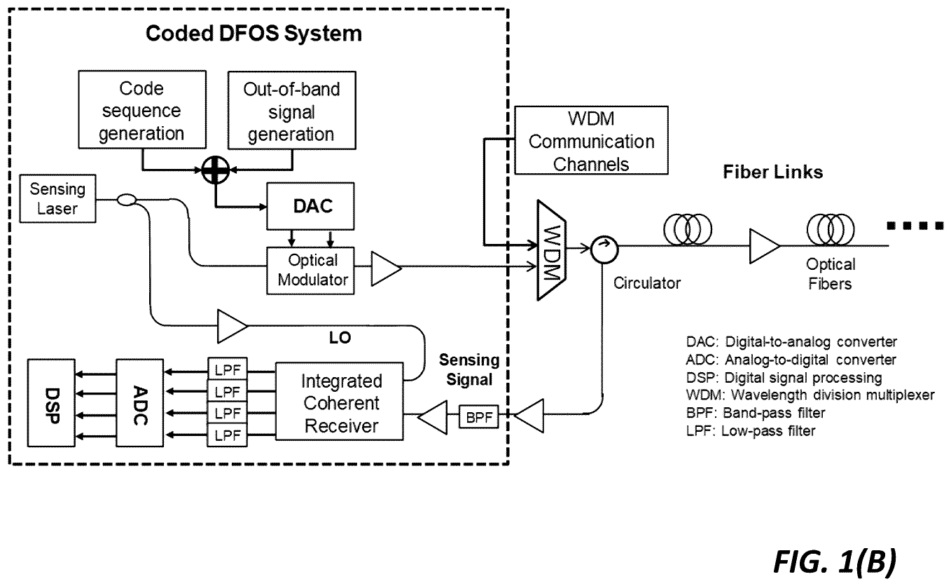

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

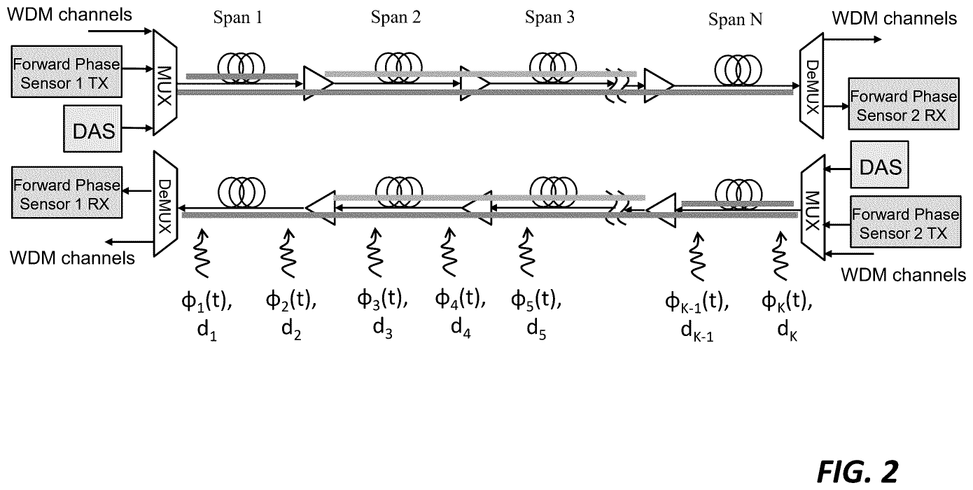

FIG. 2 is a schematic diagram showing an illustrative implementation of forward phase sensor and DAS for SIC in bidirectional WDM optical fiber links between two add-drop nodes. Two forward phase sensors are deployed for phase monitoring of each direction. Two DAS are used to monitor fiber spans immediately adjacent to add-drop nodes according to aspects of the present disclosure.

According to aspects of the present disclosure, a WDM network includes both DAS and forward phase sensing systems deployed at add/drop nodes of an optical fiber link. Whereas DAS systems can monitor the immediate fiber spans connected to the add-drop nodes, the forward phase sensors monitor the whole link between the nodes. With DAS providing precise locations of the vibration sources at immediate fiber spans, we advantageously utilize that information and successively subtract these vibration signals (by applying proper time delay according to their location) from forward phase signal systems monitoring the entire link. The resulting signals after successive interference cancellation (SIC) will contain only the phase information at the intermediate fiber spans, effectively isolating those signal sources from the those retrieved by DAS.

Shown in FIG. 2, forward phase sensors and DAS systems are connected to typical bidirectional WDM links at the add/drop nodes. For an N-span link, in this example, two forward sensors are placed at each end to monitor the total link phase changes due to vibration in each direction. Two DAS interrogators are placed at opposite nodes to monitor vibrations at span 1 and span N.

Due to isolators placed in in-line amplifiers, DAS system cannot monitor vibrations beyond these two spans. As there are multiple sources of vibrations along the fiber route, the detected forward phase signal will be the sum of all phase signals Øₖ(t) combined with time shifts in respect to their source locations dₖ. Assuming that the bidirectional link utilizes fiber cores in the same cable and the local phase change induced by vibration are identical, the accumulated phases for both directions for the whole link (blue portion) will be:

$$\begin{matrix}{∅}_{t o t a l , W - E} ( t ) = {\sum }_{k = 1}^{K} {∅}_{k} ( t - \frac{n \cdot ( L - {d}_{k} )}{c} ) \\ {∅}_{total , E - W} ( t ) = {\sum }_{k = 1}^{K} {∅}_{k} ( t - \frac{n \cdot {d}_{k}}{c} )\end{matrix}$$

where L is the total length of the link, n is the fiber refractive index, and c is speed of light. With only two forward phase signals, it is not possible to separate all the vibration sources Øₖ(t), dₖ if K>2. By cross-correlating of the two phase signals, it is possible to find the locations of the stronger vibrations to some degree depending on the vibration bandwidth, but the corresponding waveforms cannot be retrieved and isolated individually.

According to aspects of the present disclosure, we use the vibration phase and location information retrieved from DAS installed at span 1 and span N to perform successive interference cancellation on the forward phase signal. This way, we can remove the corresponding phase signal of span 1 and span N from the total forward phase signal, and resulting signal will contain phase information from vibrations generated in the intermediate spans (green portion), where there is no DAS monitoring available:

$${∅}_{i n t e r m e d i a t e , W - E} ( t ) = {∅}_{t o t a l , W - E} ( t ) - {\sum }_{u = 1}^{U} {∅}_{DAS 1 , u} ( t - \frac{n \cdot ( L - {d}_{DAS 1 , u} )}{c} ) - {\sum }_{v = 1}^{V} {∅}_{D A S 2 , v} ( t - \frac{n \cdot {d}_{D A S 2 , v}}{c} )$$

where Ø_{DAS1,u}(t), d_{DAS1,u}, Ø_{DAS2,v}(t), d_{DAS2,v} are the vibration phase amplitudes and location retrieved by DAS1 and DAS2, respectively. d_{DAS1,X} is defined as the distance to the corresponding DAS interrogator. Note that each phase signals in the DAS monitor spans needs to be time-shifted by an amount respective to its location in order to perform successive interference cancellation correctly.

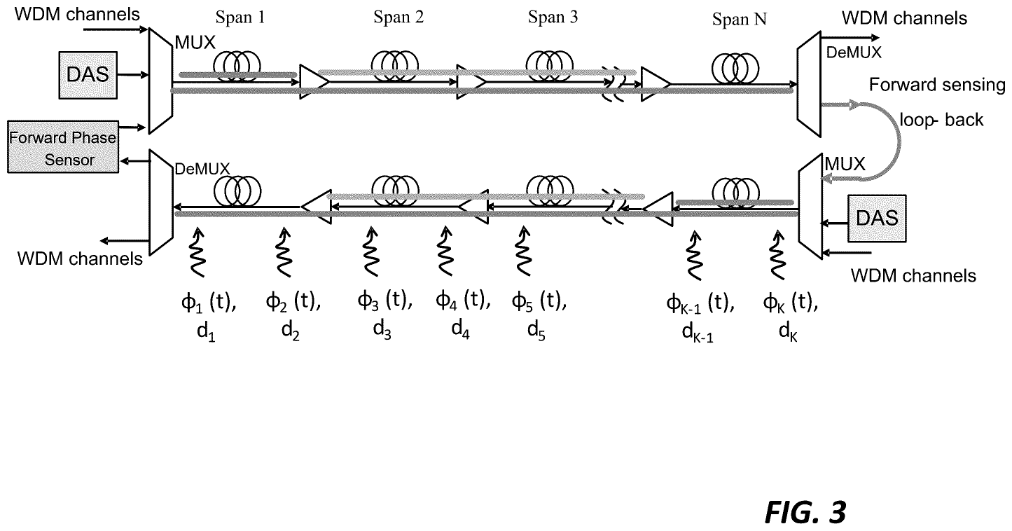

FIG. 3 is a schematic diagram showing illustrative implementation of forward phase sensor and DAS for SIC in bidirectional WDM links between two add-drop nodes. In this case, only one forward phase sensor is used for loop-back operation, and the number of DAS is two, according to aspects of the present disclosure. With reference to that FIG. 3, there it shows a similar implementation of our inventive technique for forward phase sensing utilizing loop-back scheme.

In the loop-back scheme, only one forward phase sensor is placed at one end of the link while its signal is looped back from the other end. Loop-back phase sensing has the advantage of self-homodyne detection and much lower level of laser phase noise. The retrieved phase signal after loop back will be:

$${∅}_{t o t a l , L B} ( t ) = {\sum }_{k = 1}^{K} ( {∅}_{k} ( t - \frac{n \cdot ( 2 L - {d}_{k} )}{c} ) + {∅}_{k} ( t - \frac{n \cdot {d}_{k}}{c} ) )$$

Similar successive interference cancellation can be performed using the retrieved phase signals from the two DAS installed:

$${∅}_{i n t e r m e d i a t e , L B} ( t ) = {∅}_{t o t a l , L B} ( t ) - {\sum }_{u = 1}^{U} ( {∅}_{D A S 1 , u} ( t - \frac{n \cdot ( 2 L - {d}_{DAS 1 , u} )}{c} ) + {∅}_{D A S 1 , u} ( t - \frac{n \cdot {d}_{D A S 1 , u}}{c} ) ) - {\sum }_{v = 1}^{V} ( {∅}_{D A S 2 , v} ( t - \frac{n \cdot ( L - {d}_{D A S 2 , v} )}{c} ) + {∅}_{DAS 2 , v} ( t - \frac{n \cdot ( L + {d}_{D A S 2 , v} )}{c} ) )$$

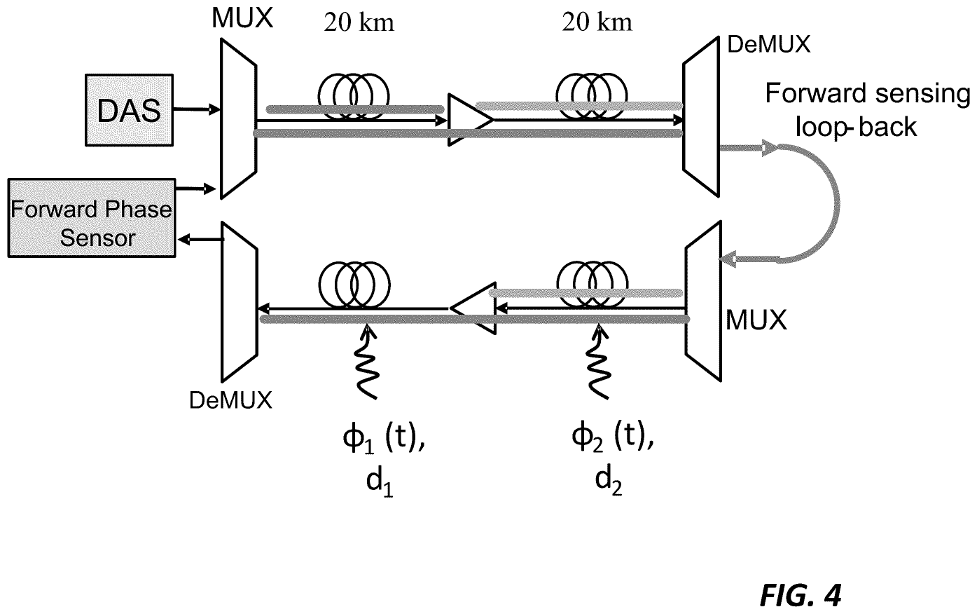

FIG. 4 is a schematic diagram of an illustrative simulation of a two-span link with loop-back forward phase sensing and DAS according to aspects of the present disclosure.

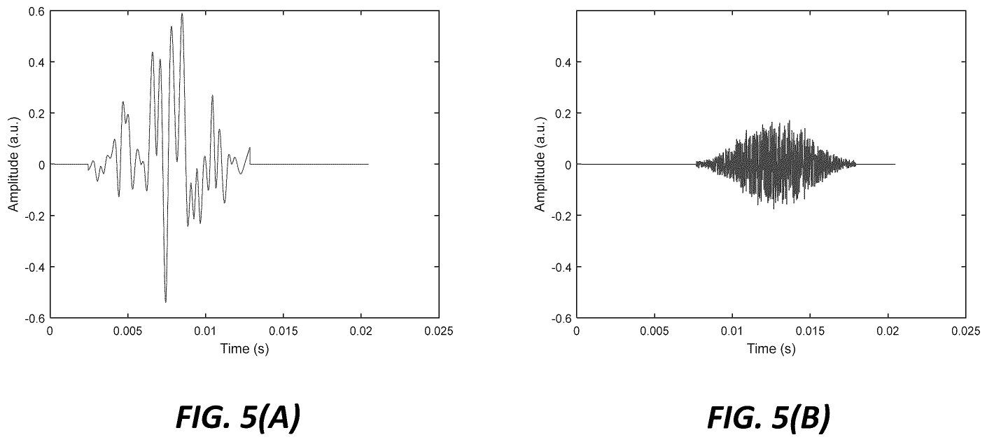

To illustrate how our inventive techniques work, we simulated our scheme using a two span fiber system, as shown in FIG. 4. Each fiber span is 20-km in length, with forward phase sensor monitoring both spans using loop-back scheme, while only the 1^{st} span is monitored by DAS. We placed two vibration signals, Ø₁(t) and Ø₂(t), at location 10-km and 30-km away from the left add/drop node. Each vibration has randomly generated phase amplitudes and different start time, as shown in FIG. 5(A) and FIG. 5(B), which are plots showing simulated vibration signal waveforms in which: FIG. 5(A) shows Ø₁(t) placed at 10-km, and FIG. 5(B) shows Ø₂(t) placed at 30-km., Ø₁(t) has a signal bandwidth below the Nyquist bandwidth of the DAS sampling rate (^{˜}5 kHz) while Ø₂(t) signal bandwidth is much higher at (^{˜}100 kHz). While forward phase signal will contain both Ø₁(t) and Ø₂(t), DAS will only pick up Ø₁(t). In this case, Ø₂(t) is the signal of interest as it is situated in a span not monitored by DAS, and Ø₁(t) is the interfering signal. It is also noted that Ø₁(t) has a larger signal amplitude than Ø₂(t) (stronger interferer), with their respective amplitudes set at 0.7 and 0.3 in arbitrary unit.

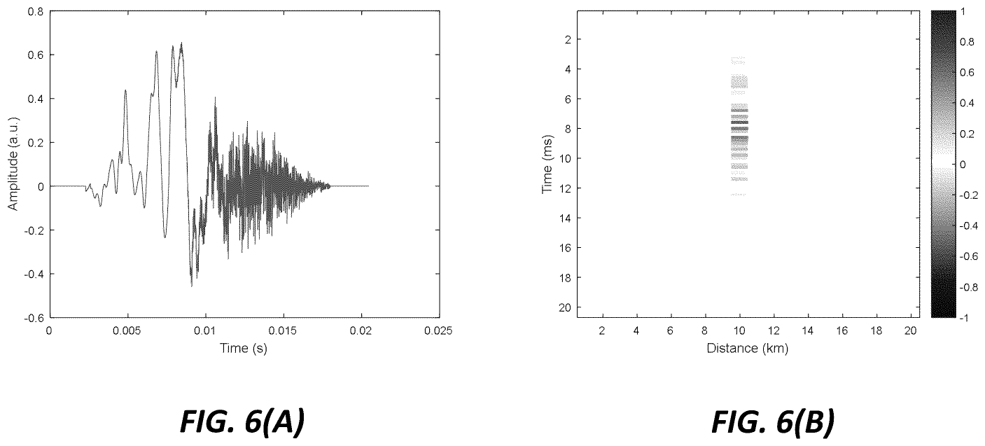

FIG. 6(A) and FIG. 6(B) are plots showing: FIG. 6(A) received forward phase signals for an entire link using a loop-back simulated vibration signal waveforms, and FIG. 6(B) shows a phase waterfall plot retrieved by the DAS for span 1 with 1-km spatial resolution.

FIG. 6(A) plots the retrieved phase signal for the loop-back forward phase sensor. As the sensor signal traverse the link twice, it experiences the phase changes incurred by each vibration signal Ø₁(t), Ø₂(t) twice at different time delays:

$${∅}_{t o t a l , L B} ( t ) = {∅}_{1} ( t - \frac{n \cdot ( 2 L - {d}_{1} )}{c} ) + {∅}_{1} ( t - \frac{n \cdot {d}_{1}}{c} ) + {∅}_{2} ( t - \frac{n \cdot ( 2 L - {d}_{2} )}{c} ) + {∅}_{2} ( t - \frac{n \cdot {d}_{2}}{c} )$$

where d₁=10 km, d₂=30 km, and L=40 km. As noted, FIG. 6(B) shows the waterfall plot retrieved by DAS with spatial resolution of 1-km and sampling rate of 5-kHz. By examining the waterfall plot, we can completely capture the Ø₁(t) phase and location information and use them to perform SIC on the forward phase signal in FIG. 5(a). Note that the 1-km spatial resolution for the DAS waterfall plot was chosen to match the sampling rate of the forward phase sensor (200-kHz), so that the adjacent location on the DAS will correspond to one step shift in time for the SIC process. If the inherent DAS resolution is finer, then one integrate the phase signals across adjacent locations in the waterfall trace to obtain the phase amplitudes at the desire resolution for SIC. In this example, the SIC process for removing Ø₁(t) becomes:

$${∅}_{span 2 , LB} ( t ) = {∅}_{total , L B} ( t ) - {∅}_{1} ( t - \frac{n \cdot ( 2 L - {d}_{1} )}{c} ) + {∅}_{1} ( t - \frac{n \cdot {d}_{1}}{c} ) = {∅}_{2} ( t - \frac{n \cdot ( 2 L - {d}_{2} )}{c} ) + {∅}_{2} ( t - \frac{n \cdot {d}_{2}}{c} )$$

Thus, we effectively end up with the loop-back phase signal with only impact of Ø₂(t). The resulted trace after SIC is plotted in

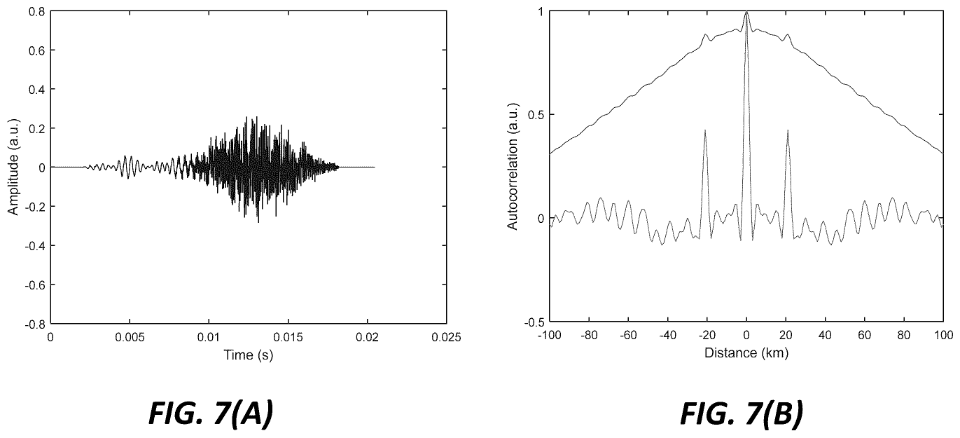

FIG. 7(A), which shows a received retrieved loop-back phase signal for span 2 after SIC. As observed, most of the interference from Ø₁(t) is removed. There is small residual interference which is likely due to implementation of imperfect signal filtering which causes aliasing effect during SIC processing.

In FIG. 7(B), which shows autocorrelation results of the loop-back phase signal before (blue) and after (red) SIC process a phase waterfall plot retrieved by the DAS for span 1 with 1-km spatial resolution, we plot the autocorrelation traces of the original loop-back phase signal in blue and the one with SIC in red. Peaks in correlation traces can provide information on the location of the vibration signal. With higher signal amplitude and slow varying signal waveform, Ø₁(t) effectively masked out the peaks that would be created from Ø₂(t) in the original signal without SIC. With the available information retrieved by DAS, we can suppress the interference of Ø₁(t) by SIC, and the resulted autocorrelation shows two clear side peaks at distance 20-km away from the main peak, indicating the location of Ø₂(t), as 2L−d₂−d₂=20 km.

In our inventive systems and methods, a vibration source with high signal bandwidth like Ø₂(t) can be used to calibrate the SIC process. Such a source can be placed in the intermediate spans without DAS monitoring. By performing autocorrelation on the resulted phase signals after SIC process and evaluating the quality of the correlation peaks, we can fine tune the phase amplitude and location-base time shifts for the interfering signals retrieved by DAS.

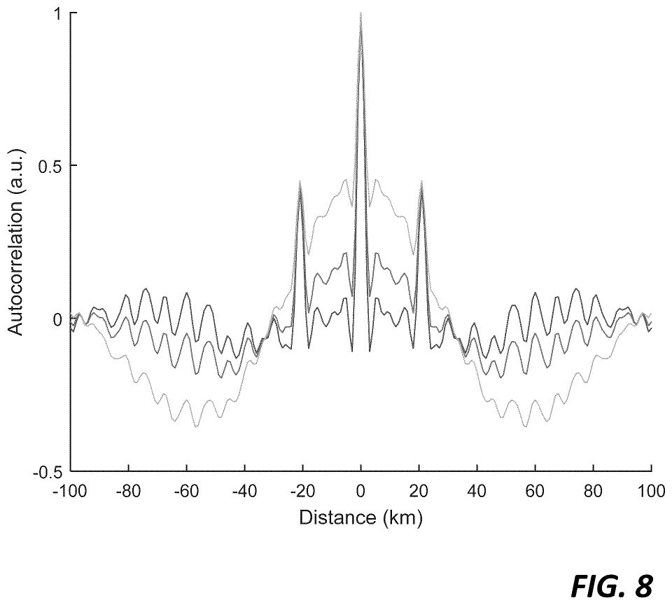

FIG. 8 is an example and is a plot showing autocorrelation traces of SIC processed phase signals with different time-shift errors according to aspects of the present invention.

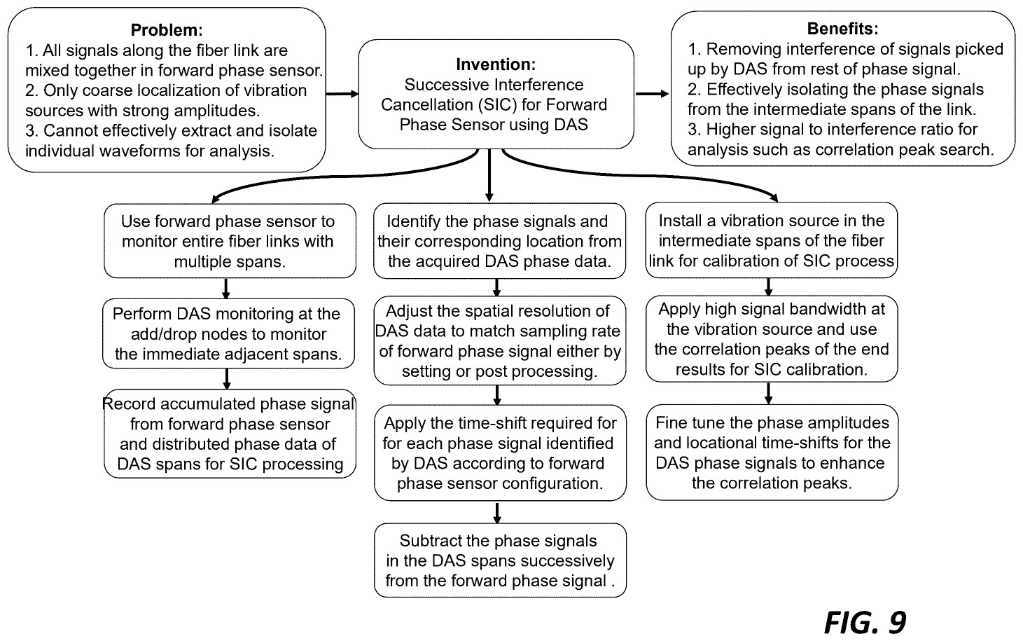

FIG. 9 shows a feature diagram in a hierarchical format according to aspects of the present disclosure.

As we have noted, existing optical networks have optical repeaters with isolators, which prohibits the use of fiber sensing technologies like DAS and DTS that utilize Rayleigh and Raman back scattering effects in fiber. On the other hand, forward transmission-based sensing utilizing coherent laser phase interferometry has no such limitation and therefore can be directly applied to multi-span fiber networks as an inserted optical channel in the WDM spectrum. Localization of events using forward phase sensing can be implemented using bidirectional laser interferometry, loop-back laser interferometry with additional RF carrier paths at far-end, or directly recovery of optical phase from DSP of coherent optical transponders for WDM communication.

It is common to use fiber spools of various lengths to verify the performance of fiber transmission and sensing systems in a laboratory setting. Multiple fiber spools can be constructed to test the reach distance and localization performance of an optical fiber sensing technology. For forward-based sensing using phase interferometry, this creates a potential issue as all the phase disturbance in the path of the optical links will be accumulated. Due to their proximity, the fiber wounds in the same fiber spool are picking up the same environmental disturbance. Thus, the phase noises from the surrounding environment will be much more prominent when using fiber-spools as opposed to sensing on regular field fiber cable layouts in the linear configuration. The same issue can also influence the measurement of laser phase noise when utilizing self-homodyne phase-delay interferometry, as the environmental noise picked up by the fiber spools can end up to be more dominant than the intrinsic laser phase noise.

One major difference between sensing and communications is lie in system testing. Data transmission experiments typically emulate a real-world link with fiber spools, either in a re-circulating loop or in a straight-line configuration. Provided the lab test bed and fiber spools accumulate the correct amount of amplifier noise and nonlinear interference, there should be minimal difference between the performance results of a lab test versus a field test, as differences between the two, such as polarization-mode dispersion (PMD) between fiber in spooled or cabled condition, is expected to be within the length of the transponder's equalizer and contribute minimally to performance degradation. In sensing however, lab fiber spools behave like fiber microphones that detects all the ambient noises in the room, including fan noise, building sway, equipment vibration, temperature fluctuation from air-conditioning, etc. Moreover, due to the size scale of the spool being smaller than the acoustic wavelength below a few hundred Hz, it is possible that ambient noise may add coherently—i.e., its power increasing as the square of fiber spool length rather than linearly. As environmental noise dominates the measurement, it is difficult to determine the sensitivity of the DFOS system.

Additionally, there has also been recent interest in sensors based on measurement of accumulated phase change over an entire link. In order for a vibration of interest—e.g., seismic wave—to be detectable, its phase power spectral density (PSD) must have components above the ambient noise contributed by the rest of the link. It is therefore of interest to characterize how phase PSD grow with distance

### Experimental Setup

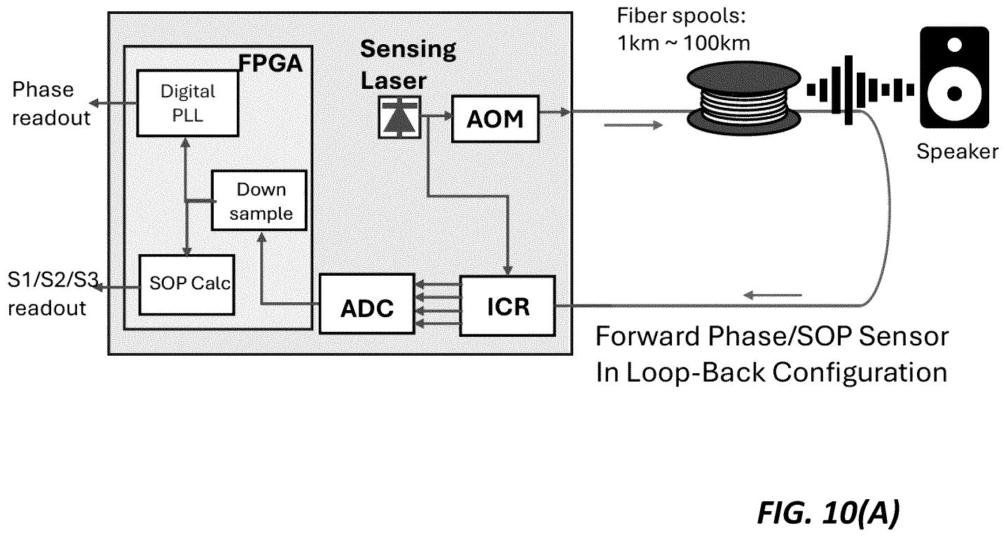

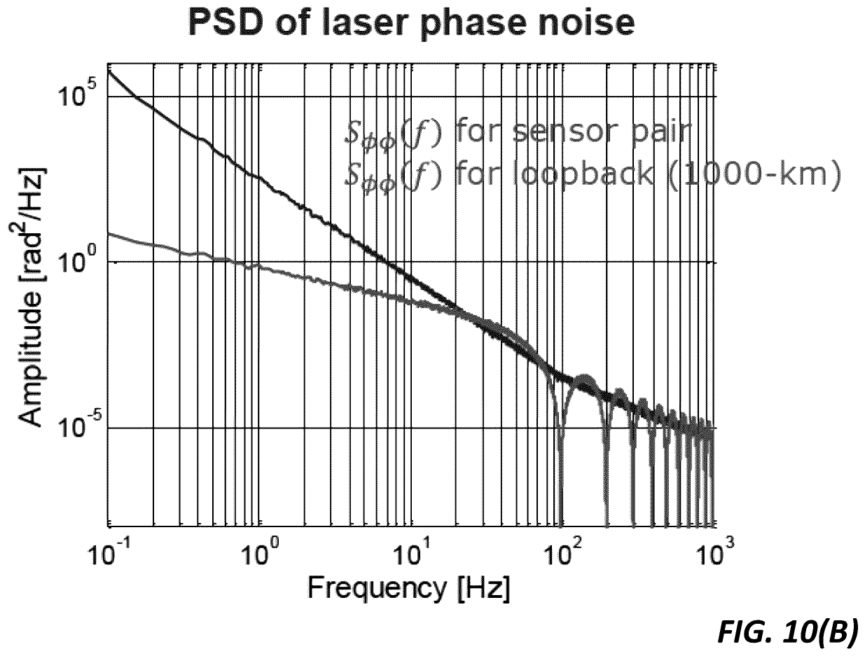

FIG. 10(A) and FIG. 10(B) show: FIG. 10(A) experimental setup using loop-back real-time phase and SOP sensing system and received, and FIG. 10(B) a plot of PSD laser phase noise showing Amplitude vs. Frequency according to aspects of the present disclosure.

FIG. I0(A) shows the measurement setup for accumulated phase signal on the fiber spools collected from the environmental noise and generated acoustic signals. We utilized a real-time phase and SOP sensor with digital signal processing implemented on FPGA. Coherent laser phase interferometry was used to detect the optical phase change in the fiber path with self-homodyne detection in a loop-back configuration. The sensing laser has a wavelength of 1550.12 nm and intrinsic linewidth of −100-Hz. An acoustic optical modulator (AOM) operating in continuous-wave (CW) is used to shift the optical frequency so that the LO and the signal are offset by 80-MHz, as the integrated coherent receiver (ICR) is AC-coupled. A 250-MHz sample rate ADC was used to digitize the in-phase and quadrature lanes in both X and Y polarizations. The digitized signals were first frequency shifted and low-pass filtered, before down-sampling to 390.625 kHz for phase and SOP signal extraction. Standard SOP calculation was performed using the X and Y signal amplitudes, while a digital phase-locked loop was implemented to extract the optical phases in both X and Y polarization before aligning and combining the phase results. The corner frequency of the PLL on the low-end can be adjusted between 0.I-Hz to I-Hz depending on the measurement requirements.

Fiber spools of various length from I-km to 100-km were placed in a “quiet” room with air-conditioning and average sound level of 30-dBa. Optical phase fluctuation due to environmental noise were measured using different lengths of fiber spools to study the phase accumulation effect. For phase accumulation from generated acoustic signal, a sound speaker with +/−3-dB equalized output level between 70 Hz 20-kHz was also used to play a chirped acoustic waveform. The chirp signal sweeps from 50-Hz to 2-kHz with 10-s duration. The speaker, which utilizes a 5″ dual concentric point source which allows for wide equalized spatial range, was placed at 2-ft away from the spool under test. The average sound level measured at the location of the fiber spools is 80-dBa.

The experimental setup is shown in FIG. 10(A). We used a real-time implementation of the technique described in [X] measuring accumulated phase change in forward transmission. The transmitter launches a continuous-wave (CW) signal at −1550.12 nm at xx dBm. The receiver performs interferometric detection using a standard coherent receiver where the local oscillator (CW) is also at −1550.12 nm. The real- and imaginary components of the two signal polarizations are sampled and digitized. The two polarizations are phase aligned and summed, and instantaneous phase is obtained using the unwrapped phase.

Test fiber spools are used and an excitation source is a sub-woofer are placed at a distance from the spool. Our test signal is a chirp:

$$x ( t ) = A exp ( j 2 π {\int }_{0}^{t} v ( τ ) d τ ) \qquad ( 1 )$$

Where the instantaneous where the instantaneous frequency v(t) vary exponentially from v1=xx to vh=yy Hz (equation) over a time duration of TP=zz seconds.

$$v ( t ) = {v}_{l} + \frac{{v}_{h} - {v}_{l}}{e - 1} exp ( \frac{t}{{T}_{p}} ) , 0 \leq t \leq {T}_{p} \qquad ( 2 )$$

The chirp signal is repeated at a rate of Rp=1/Tp=zz Hz. As the speed of sound is −340 m/s, the wavelength of the acoustic excitation is greater than the diameter of the spooled fiber below −xx Hz, and less than the diameter of the spooled fiber above −xx Hz, allowing the rate of phase accumulation in the two regimes to be tested with the same probe signal. The amplitude of the probe signal was set such that no phase jumps (caused by phase changing more than 211 between samples) occurred even on the longest 100-km spool

### Experimental Results

Using the laser specs provided by the vendor, we simulated plotted the phase noise power spectral density distribution in FIG. I0(B) for the scenario of I-km, 10-km, and 100-km in inserted fiber delays in the absence of environmental noise. To understand our results, we plotted the optical phase psd accumulated through different length of fiber spools due to environmental noise. After comparing, we observe that the intrinsic laser phase noise in the delay interferometry measurements can be ignored. We also plotted the optical phase psd picked up by the fiber spools when the chirp acoustic signal was played. At low frequencies between 50-200 Hz, where the wavelength of the sound wave is much longer than the dimensions of the fiber spools, the phase accumulated much faster as each of the fiber wounds is experiencing the same phase disturbance, so the ratio of the detected phase psd level is greater than the ratio of the fiber length in the spool. In the high frequency range, above I kHz, the acoustic wavelength is much shorter than the dimension of the spool so each fiber wound will experience both positive phase and negative phase so there is not significant phase accumulation with increased fiber distance.
Using coherent laser phase interferometry, we measure the strain accumulation rate in fiber spools in the presence of ambient acoustic noise. The frequency dependence of environmental noise influences on forward phase sensing systems are verified.

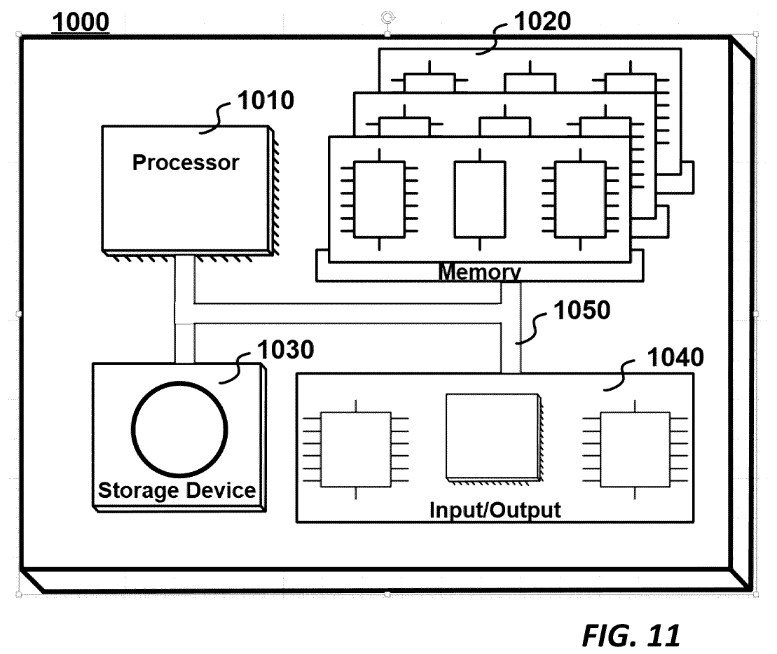

FIG. 11 is a schematic block diagram of an illustrative computer system on which methods according to the present disclosure may operate. Shown in the figure is an illustrative computer system 1000 suitable for implementing methods and systems according to an aspect of the present disclosure. As may be immediately appreciated, such a computer system may be integrated into another system and may be implemented via discrete elements or one or more integrated components. The computer system may comprise, for example a computer running any of several operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

While we have presented our inventive concepts and description using specific examples, our invention is not so limited. Accordingly, the scope of our invention should be considered in view of the following claims.

1. A method for separating vibration signals in a multi-span optical fiber link, the method comprising:
deploying at least one distributed acoustic sensing (DAS) system configured to monitor a first portion of the optical fiber link;
deploying at least one forward phase sensing system configured to monitor a second portion of the optical fiber link;
obtaining a first signal from the at least one DAS system, the first signal including a first phase amplitude and a first location of at least one vibration source within the first portion of the optical fiber link;
obtaining a second signal from the at least one forward phase sensing system, the second signal representing an accumulation of phase changes from all vibration sources along the second portion of the optical fiber link;
applying a successive interference cancellation (SIC) process to the second signal by using the first phase amplitude and the first location to subtract a contribution of the at least one vibration source from the second signal; and
generating a third signal representing the vibration signals from a third portion of the optical fiber link, wherein the third portion is a part of the second portion and is not monitored by the at least one DAS system.

2. The method of claim 1, further comprising:
applying a time delay to the first phase amplitude based on the first location of the at least one vibration source; and
calibrating the SIC process using a known artificial vibration source with a known signal profile placed in a portion of the optical fiber link non monitored by the DAS system.

3. The method according to claim 1, wherein the at least one forward phase sensing system uses a loop-back configuration.

4. The method according to claim 1, wherein the at least one DAS system and the at least one forward phase sensing system are deployed at a bidirectional wavelength division multiplexed (WDM) link between two add/drop nodes.

5. The method according to claim 1, wherein the at least one DAS system is deployed to monitor vibrations in a fiber span adjacent to an add-drop node of a WDM network.

6. A system for separating vibration signals in a multi-span optical fiber link, comprising:
a distributed acoustic sensing (DAS) system configured to monitor a first portion of the optical fiber link and to generate a first signal, the first signal comprising a first phase amplitude and a first location of at least one vibration source within the first portion of the optical fiber link;
a forward phase sensing system configured to monitor a second portion of the optical fiber link, wherein the second portion includes the first portion, and to generate a second signal representing an accumulation of phase changes from all vibration sources along the second portion of the optical fiber link;
a processor in communication with the DAS system and the forward phase sensing system, the processor configured to:
apply a successive interference cancellation (SIC) process to the second signal by using the first phase amplitude and the first location to subtract the contribution of the at least one vibration source from the second signal;
generate a third signal representing the vibration signals from a third portion of the optical fiber link, wherein the third portion is a part of the second portion and is not monitored by the DAS system.
